(19) United States
(12) Patent Application Publication
(10) Pub. No.: US 2020/0177529 A1
(43) Pub. Date: Jun. 4, 2020

(54) CONTEXTUALLY CORRELATED LIVE CHAT COMMENTS IN A LIVE STREAM WITH MOBILE NOTIFICATIONS

(71) Applicant: International Business Machines Corporation, Armonk, NY (US)

(72) Inventors: Craig M. Trim, Ventura, CA (US); Martin G. Keen, Cary, NC (US); Khwaja Shaik, Jacksonville, FL (US); Cesar Augusto Rodriguez Bravo, Alajuela (CR)

(21) Appl. No.: 16/204,318

(22) Filed: Nov. 29, 2018

(51) Int. Cl. H04L 12/58; H04L 29/06

(52) U.S. Cl. CPC H04L 51/046; H04L 65/1069; H04L 51/24

(57) ABSTRACT

Aspects of the present invention disclose a method, computer program product, and system for correlating comments of a live stream chat with content discussed in a live stream. The method includes one or more processors determining a classification of content within a segment of a live stream. The method further includes identifying one or more messages in a chat session associated with the live stream that correspond to the segment of the live steam. The method further includes determining respective classifications corresponding to the identified one or more messages in the chat session associated with the live stream that correspond to the segment of the live stream. The method further includes determining that a message of the identified one or more messages has a respective determined classification that correlates to the determined classification of the content within the segment of the live stream.

### BACKGROUND OF THE INVENTION

The present invention relates generally to the field of Internet communications, and more particularly to correlating live chat comments with content of a live stream.

In recent years, live streaming information has increased with the continued growth of social media broadcasting. Live streams typically consist of the live stream video of the presentation and a comments section for viewers of the live stream. Live streams can have countless amounts of viewers at a given time, which can lead to high traffic in the comments sections.

Live streaming is multimedia that is simultaneously recorded and broadcast in real-time to an end-user. User interaction is a major component in the popularity of live streaming events, because user interaction gives a user the ability to interact with the broadcaster during the live event. Lives streams can also include metadata. Visual recognition is the ability of a computer to perceive physical properties (e.g., metadata) of an object and applying semantic attributes to the object.

Natural language processing (NLP) is a branch of artificial intelligence that helps computers understand, interpret, and manipulate human language. Natural language processing encompasses a broad range of tasks that often intertwine in a practical setting. For example, a computer can apply speech recognition and parsing to a voice recording to gain an understanding of what the voice recording is conveying.

### SUMMARY

Aspects of the present invention disclose a method, computer program product, and system for correlating comments of a live stream chat with content discussed in a live stream. The method includes determining, by one or more processors, a classification of content within a segment of a live stream. The method further includes identifying, by one or more processors, one or more messages in a chat session associated with the live stream that correspond to the segment of the live steam. The method further includes determining, by one or more processors, respective classifications corresponding to the identified one or more messages in the chat session associated with the live stream that correspond to the segment of the live stream. The method further includes determining, by one or more processors, that a message of the identified one or more messages has a respective determined classification that correlates to the determined classification of the content within the segment of the live stream.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for correlating comments of a live stream chat with content discussed in a live stream, in accordance with embodiments of the present invention.

FIG. 3A depicts an example video segment that includes video and audio data a program analyzes, in accordance with embodiments of the present invention.

FIG. 3B depicts an example video segment that includes a general comment section that a program generates, in accordance with embodiments of the present invention.

FIG. 4 depicts a block diagram of components of a computing system representative of a client device, presenter device, and server of FIG. 1, in accordance with embodiments of the present invention.

### DETAILED DESCRIPTION

Embodiments of the present invention allow for a user to view an annotated feed of chat content that correlates with a topic of a segment of a live stream. Embodiments of the invention determine classifications of presentation and chat content to correlate topics of the presentation content with comments of the chat content. The correlation of classifications of the presentation and the chat content allows a user to view comments of the chat content that are relevant to a current topic of the presentation content. Embodiments of the present invention allow a presenter of the presentation content to receive a notification with a comment of the chat content.

Some embodiments of the present invention recognize that a comment section of a live stream receives a great deal of high traffic due to large numbers of participants of a live stream. For example, a broadcaster giving a symposium and taking questions from a live chat would find it difficult to efficiently select questions pertinent to a discussion when a multitude of viewers are commenting in the live chat concurrently. Various embodiments of the present invention improve the efficiency of managing high comment traffic by utilizing visual recognition and NLP to identify comments relevant to a current topic of a live stream. Furthermore, reducing comment traffic a broadcaster views by generating a subset of comments identified as relevant.

In various embodiments, the present invention provides an improvement to a network by reducing the amount of network resources expended by sending data packets to a presenter that are associated with comments that equal or exceed a particular rank. For example, embodiments of the present invention include notifications, which may contain comments that receive a score greater than or equal to a threshold score, that are transmitted to a presenter as opposed to transmitting all of the relevant comment traffic.

Embodiments of the present invention recognize that challenges exist with the ability to interact via a live stream. Various embodiments of the present invention improve a live stream through real-time analysis of streaming data that classifies and restructures the chat component of the streaming data based on determined classifications. Embodiments of the present invention also improve the playback quality of a live stream by creating a classification schema that includes classified segments of data that are readily searchable.

Implementation of embodiments of the invention may take a variety of forms, and exemplary implementation details are discussed subsequently with reference to the Figures.

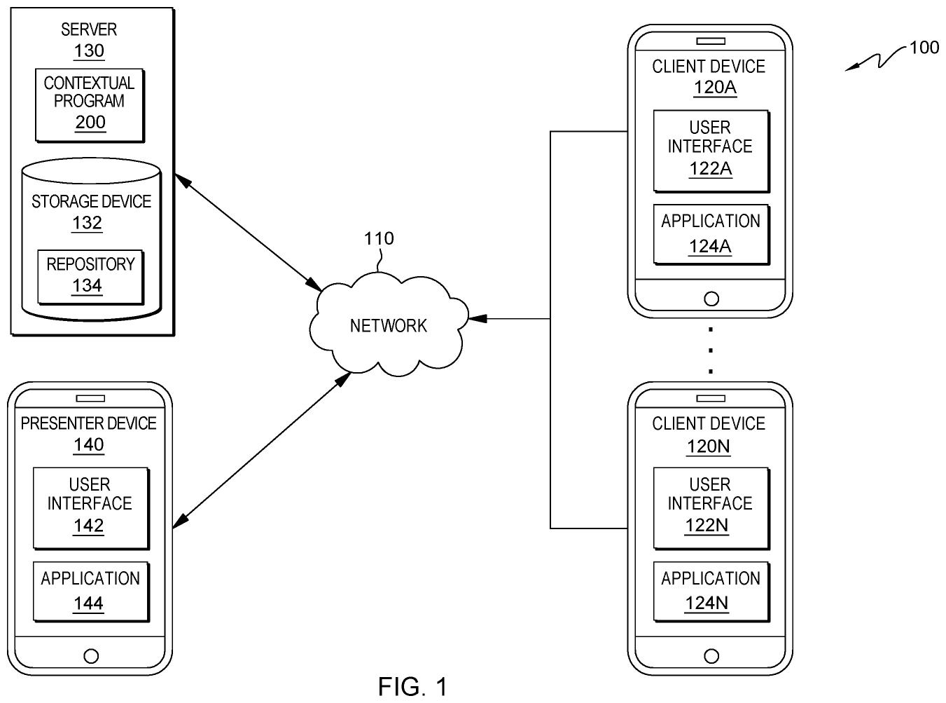

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes client device 120A through client device 120N, server 130, and presenter device 140, all interconnected over network 110. In one embodiment, client device 120A through client device 120N, server 130, and presenter device 140 communicate through network 110. Network 110 can be, for example, a local area network (LAN), a telecommunications network, a wide area network (WAN), such as the Internet, or any combination of the three, and include wired, wireless, or fiber optic connections. In general, network 110 can be any combination of connections and protocols, which will support communications between client device 120A through client device 120N, server 130, and presenter device 140, in accordance with embodiments of the present invention.

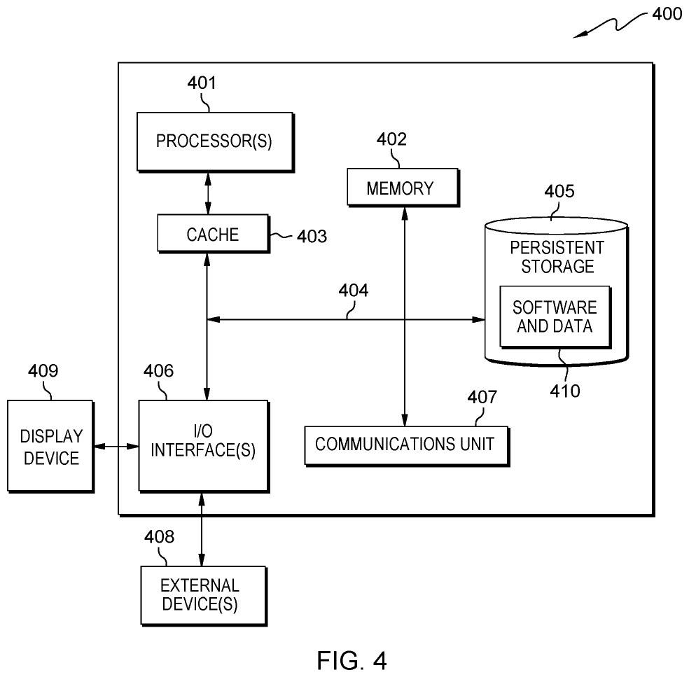

Client device 120A through client device 120N are representative of a plurality of devices capable of executing computer readable program instructions. In various embodiments of the present invention, client device 120A through client device 120N may be a workstation, personal computer, digital video recorder, media player, personal digital assistant, mobile phone, or any other device capable of executing computer readable program instructions, in accordance with embodiments of the present invention. For example, client device 120A through client device 120N are personal computers of users that are participating in a live stream. Client device 120A through client device 120N may include components as depicted and described in further detail with respect to FIG. 4, in accordance with embodiments of the present invention.

Client device 120A through client device 120N and presenter device 140 include respective instances of user interface 122A through user interface 122N and user interface 142, which each correspond to a respective device and perform equivalent functions in the respective device. In various embodiments of the present invention a user interface is a program that provides an interface between a user of a device and a plurality of applications that reside on the client device. A user interface, such as user interface 122A, refers to the information (such as graphic, text, and sound) that a program presents to a user, and the control sequences the user employs to control the program. A variety of types of user interfaces exist. In one embodiment, user interface 122A is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 122A is a script or application programming interface (API).

Client device 120A through client device 120N and presenter device 140 include respective instance of application 124A through application 124N and application 144, which each correspond to a respective device and perform equivalent functions in the respective device. An application frequently serves to provide a user with similar services accessed on personal computers (e.g., web browser, playing music, or other media, etc.). In one embodiment, a user utilizes application 124A of client device 120A to access the presentation and the chat content. For example, application 124A is a web browser of a personal computer that a user can utilize to view a live stream of a broadcaster. In another embodiment, a user utilizes application 124A of client device 120A to add an interaction with the presentation content. For example, a user uses application 124A and user interface 122A to hit a “like” button on the live stream of the broadcaster.

In another embodiment, a presenter utilizes application 144 of presenter device 140 to access chat content. For example, a broadcaster uses application 144 to view comments of users on the live stream of the broadcaster. In yet another embodiment, a user utilizes application 124N of client device 120N to add a comment to the chat content. For example, a user viewing the live stream of the broadcaster uses a personal computer to add a comment to the chat of the presentation.

In various embodiments of the present invention, server 130 may be a desktop computer, a computer server, or any other computer systems, known in the art. In certain embodiments, server 130 represents computer systems utilizing clustered computers and components (e.g., database server computers, application server computers, etc.), which act as a single pool of seamless resources when accessed by elements of data processing environment 100 (e.g., client device 120A through client device 120N and presenter device 140). In general, server 130 is representative of any electronic device or combination of electronic devices capable of executing computer readable program instructions. Server 130 may include components as depicted and described in further detail with respect to FIG. 4, in accordance with embodiments of the present invention.

Server 130 includes storage device 132, repository 134, and contextual program 200. Storage device 132 can be implemented with any type of storage device, for example, persistent storage 405, which is capable of storing data that may be accessed and utilized by presenter device 140 and server 130, such as a database server, a hard disk drive, or a flash memory. Storage device 132 stores numerous types of data which may include a database or repository. In various embodiments of the present invention a database or repository may include classifications (e.g., an identifier used in the systematic arrangement of categories according to established criteria), which relate to subjects of a live stream. Repository 134 is a corpus, which includes metadata relating to classifications of the presentation and the chat content, that may be compiled in storage device 132. For example, storage device 132 may include a database of classifications that correspond to a current topic of a segment of the presentation content and/or a comment of the chat content, which contextual program 200 accesses to correlate related classifications and stores the correlation metadata in repository 134.

Contextual program 200 utilizes visual recognition and natural language processing (NLP) to classify chat and presentation content. For example, NLP techniques include sentence splitting, tokenization, POS tagging, chunking, dependency parsing, anaphora resolution, optical character recognition, etc. In another example, contextual program 200 uses visual recognition and NLP to derive a title of a slide present in a live stream of a broadcaster and determines a classification (e.g., a topic) of the presentation content the broadcaster is currently discussing based on the derived title. In another example, contextual program 200 parses (e.g., NLP) live chat content to determine a topic (e.g., classification) of a comment of a user. Contextual program 200 can display contextually relevant chat content to a user viewing the presentation and chat content using a respective instance of client device 120A through client device 120N. For example, contextual program 200 determines relevant comments of the live chat content and annotates the live chat content feed. Additionally, contextual program 200 can send a notification to presenter device 140 that includes contextually relevant comments. For example, contextual program 200 sends a notification to a broadcaster of a livestream, which includes a comment that is relevant to the content that the broadcaster is currently presenting.

In various embodiments of the present invention, presenter device 140 may be a workstation, personal computer, digital video recorder, media player, personal digital assistant, mobile phone, or any other device capable of executing computer readable program instructions, in accordance with embodiments of the present invention. For example, presenter device 140 is a mobile phone of a broadcaster of a live stream. In general, presenter device 140 is representative of any electronic device or combination of electronic devices capable of executing computer readable program instructions, and share equivalent functionality and capability as client device 120A. Presenter device 140 may include components as depicted and described in further detail with respect to FIG. 4, in accordance with embodiments of the present invention.

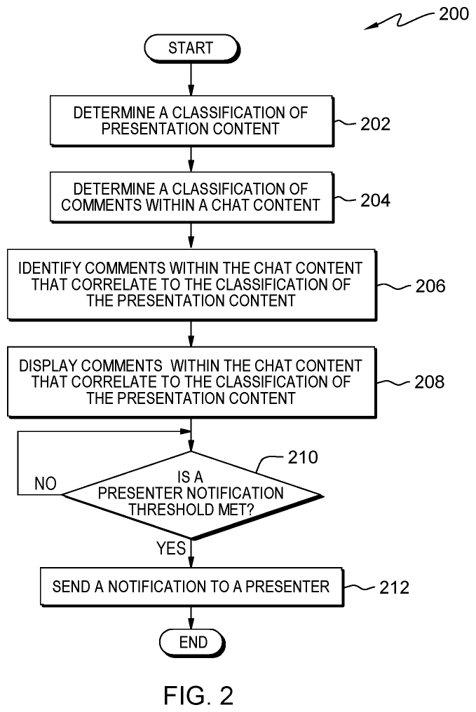

FIG. 2 is a flowchart depicting operational steps of contextual program 200, a program for correlating comments of a live stream chat with content discussed in a live stream. In one embodiment, contextual program 200 initiates in response to the commencement of presentation content, which includes chat content.

In step 202, contextual program 200 determines a classification of presentation content. In one embodiment, contextual program 200 utilizes NLP to determine a classification of speech and unstructured written text of presentation content and stores the classification in a database of storage device 132. For example, contextual program 200 uses speech recognition (e.g., NLP) to derive a textual representation of audio content of a live stream, determines a classification (e.g., a topic) of the audio of the live stream, and stores the classification in a database on a server. In another example, contextual program 200 uses optical character recognition (e.g., NLP) to derive the title of a slide in the video content of the live stream, determines a topic of the slide, and stores the topic in a database on a server. In another embodiment, contextual program 200 utilizes visual recognition to determine classifications of presentation content. For example, contextual program 200 uses visual recognition to identify objects (e.g., people, places, etc.) appearing in video content of a live stream. In this example, contextual program 200 may determine a classification based on the identified objects.

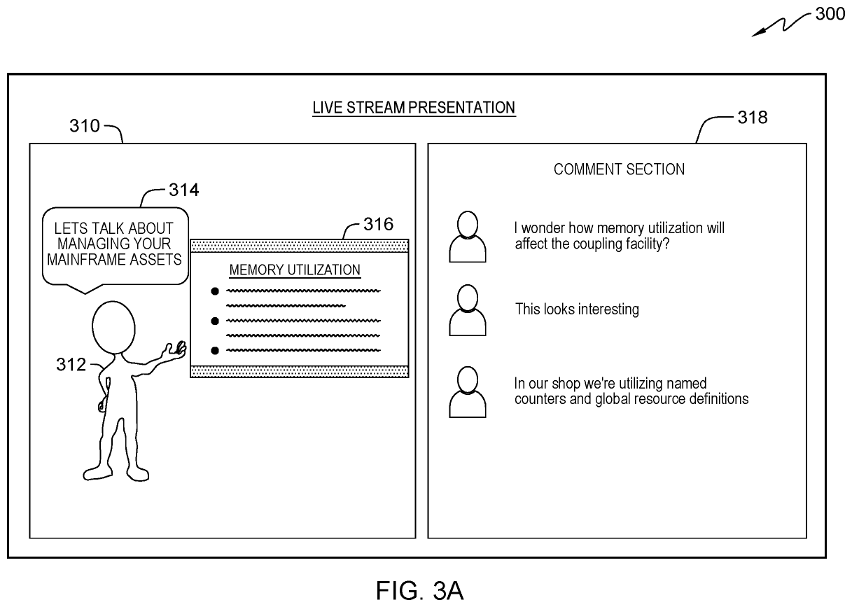

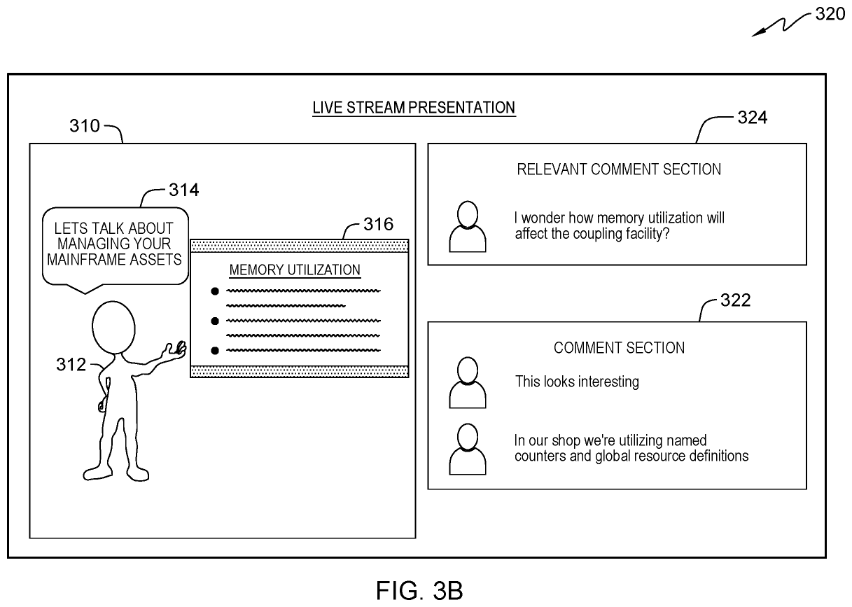

FIG. 3A depicts video segment 300, which is an example of a segment of a live stream that includes video data and live chat content. Video segment 300 includes live stream 310, speaker 312, audio segment 314, presentation slide 316, and comment section 318. Live stream 310 includes video (e.g., visual content) and audio data (e.g., audio content), within video segment 300, which includes audio segment 314 and presentation slide 316. Speaker 312 provides audio segment 314, which refers to presentation slide 316. In this example, speaker 312 is giving a presentation using presentation slide 316 while viewers post text in comment section 318.

In an example embodiment, contextual program 200 utilizes NLP and visual recognition to determine a classification of live stream 310 of video segment 300. For example, contextual program 200 uses NLP to determine that the classification (e.g., the topic) of audio segment 314 of speaker 312 is “managing mainframe assets.” Additionally, contextual program 200 uses visual recognition to determine that “memory utilization” is the title of presentation slide 316. Accordingly, contextual program 200 assigns video segment 300 a classification of “mainframe management” and “memory utilization” based on determined classifications of audio segment 314 and presentation slide 316.

In step 204, contextual program 200 determines a classification of comments within chat content of the presentation. In one embodiment, contextual program 200 utilizes NLP to determine a classification of unstructured written text of chat content and stores the classification in a database of storage device 132. For example, contextual program 200 uses NLP to parse a comment of chat content associated with a live streaming presentation, determines a classification (e.g., a topic) of the comment, and stores the classification in a database on a server. In another embodiment, contextual program 200 utilizes visual recognition and NLP to determine classifications of chat content. For example, contextual program 200 uses visual recognition and optical character recognition (e.g., NLP) to identify text and determine a topic, which contextual program 200 stores in a data base on a server.

In an example embodiment with respect to FIG. 3A, contextual program 200 utilizes NLP to determine a classification of comment section 318. For example, contextual program 200 parses (e.g., NLP) each comment of comment section 318 to determine a classification for each comment. In another example, contextual program 200 parses the comment “I wonder how memory utilization will affect the coupling facility?” and determines that the classification of the comment is “memory utilization.” In an additional example, contextual program 200 parses the comment “This looks interesting” in comment section 318 and determines that the classification of the comment is “general discussion.”

In step 206, contextual program 200 identifies comments within the chat content that correlate to the classification of the presentation content. In one embodiment, contextual program 200 identifies a current classification of the presentation content (determined in step 202). Also, contextual program 200 identifies classifications of messages of the chat content on server 130 that match the current classification of the presentation content, and stores structural metadata, which includes database locations of correlated classifications and video segments, of presentation and chat content in repository 134. For example, contextual program 200 determines that a broadcaster of a live stream is currently discussing a particular topic (e.g., the current classification determined in step 202). Additionally, contextual program 200 identifies comments of the chat content that have a matching classification with what the broadcaster is currently discussing, and stores metadata of the comment in a corpus (e.g., repository 134), which contextual program 200 utilizes to locate correlated presentation and chat content.

In an example embodiment with respect to FIG. 3A, contextual program 200 utilizes NLP and visual recognition to determine a classification of live stream 310 of video segment 300. For example, contextual program 200 uses NLP to determine that the classification (e.g., the topic) of audio segment 314 of speaker 312 is “memory utilization”. Contextual program 200 can use visual recognition to determine that “memory utilization” is the title of presentation slide 316. Also, contextual program 200 assigns video segment 300 a classification of “memory utilization” based on analysis of previous determinations. In another example embodiment, contextual program 200 utilizes data of repository 134 to locate a classified comment (e.g., “I wonder how memory utilization will affect the coupling facility?”) with a classification of “memory utilization,” which is correlated to the classification of video segment 300 (i.e., memory utilization), which is stored in a database of storage device 132.

In step 208, contextual program 200 displays comments within the chat content that correlate to the classification of the presentation content. In one embodiment, contextual program 200 displays correlated chat content with the presentation content. In another embodiment, contextual program 200 annotates the chat content with data of the chat content, which correlates a classification of a segment of the presentation content. For example, contextual program 200 displays comments within a chat associated with a live stream that are contextually relevant (i.e., contextual program 200 assigned the comment and the presentation segment the same classification) to a current topic of the live stream broadcast. In yet another embodiment, contextual program 200 utilizes metadata of repository 134 to retrieve data of the chat content from a database of server 130 and generates a subset of chat content to display with the presentation content. For example, contextual program 200 uses structural metadata to locate a comment on a server that correlates to a current topic of the live stream broadcast. In this example, contextual program 200 displays the comment in a window of the live chat of the live stream broadcast.

FIG. 3B depicts video segment 320, which is an example of a segment of a live stream that includes video data and live chat content. Video segment 320 includes live stream 310, speaker 312, audio segment 314, presentation slide 316, relevant comment section 326, and general comment section 322. Live stream 310 includes video and audio data, within video segment 320, which includes audio segment 314 and presentation slide 316. General comment section 322 includes the remainder of text comments of viewers as a result of contextual program 200 creating relevant comment section 326. In this example, speaker 312 is giving a presentation using presentation slide 316 while viewers post text in general comment section 322. Contextual program 200 creates relevant comment section 326, which is a subsection within the live chat content, and populates relevant comment section 326 with comments of viewers from general comment section 322 that are correlated to a classification of video segment 320.

In an example embodiment with respect to FIG. 3B, contextual program 200 displays comments of comment section 318, which correlates to the classification of video segment 320, in relevant comment section 326. For example, contextual program 200 adds the classified comment (e.g., “I wonder how memory utilization will affect the coupling facility?”) to relevant comment section 326 based on similar and or matching classifications of the classified comment and video segment 320.

In decision step 210, contextual program 200 determines whether a presenter notification threshold is met. In one embodiment, contextual program 200 determines whether data of the subset of the chat content (e.g., a number of comments relevant to the current portion of a live stream) meets a presenter notification threshold. In another embodiment, contextual program 200 determines a threshold score of the data of the subset of the chat content based on a combination of factors, such as a source; a comment type; comment engagement; and a topic of a comment. For example, contextual program 200 uses factors to determine a threshold score of a comment of the live chat. Also, contextual program 200 compares the determined score of the data of the subset of the chat content with a threshold value to determine whether the determined score is equal to and/or exceeds a presenter notification threshold score. For example, contextual program 200 utilizes NLP to analyze a comment of the annotated live chat, assigns the comment a threshold score, and compares the threshold score of the comment with a presenter notification threshold score. In another embodiment, preferences of a presenter may define a weight of the factors. For example, a presenter may set a weight of a threshold factor. In another embodiment, contextual program 200 uses a numerical scale when weighting each factor where lower numbers indicate a lower priority and greater numbers indicate a higher priority. In this embodiment, a scale of zero (0) to one-hundred (100) is used. For example, contextual program 200 may set a default weight of twenty-five (25) of one-hundred (100) to a threshold factor. In another example, contextual program 200 may use positive or negative feedback of the presenter to adjust a weight of a threshold factor.

In another embodiment, preferences of a presenter may define a presenter notification threshold score. For example, a presenter may set a presenter notification threshold score. In one example, contextual program 200 may set a presenter notification threshold score to a default score of seventy-five (75) out one-hundred (100). In another example, contextual program 200 may utilize feedback of the presenter to set the presenter notification threshold score. In yet another example, contextual program 200 may set a presenter notification threshold score based on the number of participants and/or the level of activity of participants.

In another embodiment, contextual program 200 utilizes a source threshold factor to assign a value to data of the subset of the chat content based on the status of the source. For example, contextual program 200 can score a comment of an author based on a tier of the author (e.g., presentation contributors belong to the highest tier, while high-value clients and viewers belong to respective tiers, etc.). In another example, contextual program 200 assigns a value of twenty-five (25) to a comment of an author based on the author belonging to tier one (1) (e.g., highest tier). In yet another example, contextual program 200 assigns a value of five (5) to a comment of an author based on the author belonging to tier five (5) (e.g., lowest tier).

In another embodiment, contextual program 200 utilizes NLP to assign a value to data of the subset of the chat content based on the type of sentence (e.g., declarative, interrogative, imperative, exclamatory, etc.) the data includes. For example, contextual program 200 parses a comment and determines a sentence type of a comment. In another example, contextual program 200 may assign a value (e.g., twenty-five (25)) to a comment that is a question (e.g., interrogative) or answer (e.g., declarative) to a question that is relevant to the current classification of the live stream. In yet another example, contextual program 200 may assign a value (e.g., ten (10)) to a comment that communicates excitement (e.g., exclamatory) of a user about a current classification of the live stream.

In another embodiment, contextual program 200 assigns a value to data of the subset of the chat content based on engagement with the data. For example, contextual program 200 may assign a value to a comment based on the amount of user interaction (e.g., declarations of concurrence, responses, replications, etc.) the comment receives. In another example, contextual program 200 adds a value of one (1) to a comment, up to a weighted cap total, for each like (e.g., declaration of concurrence), response (e.g., reply to the comment), or replication (e.g., repost). In yet another example, contextual program 200 assigns a comment a value of fifteen (15) of twenty-five (25) for receiving 10 (ten) likes and five (5) responses.

In another embodiment, contextual program 200 assigns a value to data of the subset of the chat content based on the classification of the data of the subset of the chat content. For example, contextual program 200 may assign a value of twenty-five (25) to a comment based on a determination that the topic of the comment matches the topic discussed in the live stream broadcast. In another embodiment, a scale of zero to one-hundred is use. For example, a value of 100 indicates a match to topic while a value of zero indicates non relevance to the topic. In another example, contextual program 200 may assign a value of zero (0) to a comment based on a determination that the topic of the comment does not match the topic discussed in the live stream broadcast. In instances where the threshold value for relevancy is established at greater than or equal to 50, a comment with an assigned value of 51 would be considered relevant whereas a comment assigned a value of 49 would not be considered relevant.

In another embodiment, contextual program 200 combines a value of each threshold factor to determine a threshold score of data of the subset of the chat content. If contextual program 200 determines that a threshold score of data of the subset of the chat content is less than a presenter notification threshold score (decision step 210, “NO” branch), then contextual program 200 continues to compare a threshold score of data of the subset of the chat content to the presenter notification threshold score (i.e., continues to execute decision step 210). For example, if contextual program 200 determines that a threshold score of a comment is fifty (50), which is less than the presenter notification threshold score of seventy-five (75), then contextual program 200 continues to compare a threshold score of respective comments with classifications correlated to the presentation content to the presenter notification threshold score of seventy-five (75).

In an example embodiment with respect to FIG. 3B, contextual program 200 determines a threshold score of a comment of relevant comment section 326. In one example embodiment, contextual program 200 determines a value for each of the threshold factors for a comment of relevant comment section 326 (e.g., “I wonder how memory utilization will affect the coupling facility?”). For example, contextual program 200 determines that the comment is from a major customer (e.g., tier one (1)) and assigns a value of twenty-five (25) to the comment. Contextual program 200 determines that a comment type of the comment is “interrogatory” and assigns a value of twenty-five (25) to the comment. Contextual program 200 determines that the comment has received no engagement activity and assigns a value of zero (0) to the comment. Contextual program 200 determines that the classification of the comment (e.g., memory utilization) matches the classification of video segment 320 and assigns a value of twenty-five (25) to the comment. Additionally, contextual program 200 combines the values of the threshold factors to determine a threshold score of seventy-five (75) for the comment of relevant comment section 326.

In step 212, contextual program 200 sends a notification to a presenter. More specifically, responsive to determining that a threshold score of data of the subset of the chat content is greater than or equal to a presenter notification threshold score (decision step 210, “YES” branch), contextual program 200 sends a notification to a presenter. For example, if contextual program 200 determines that a threshold score of a comment is seventy-five (75), which is equal to the presenter notification threshold score of seventy-five (75), then contextual program 200 sends a notification of the comment to a presenter.

In various embodiments, contextual program 200 uses a level and type of notification, which is defined by preferences of the presenter. In one embodiment, contextual program 200 sends a presenter a notification to presenter device 140. For example, contextual program 200 sends an email (e.g., a notification) to a mobile device (e.g., presenter device 140) of a presenter. In another embodiment, contextual program 200 sends a presenter a notification, which includes data of the subset of the chat content. For example, contextual program 200 sends a (short message service) SMS message that includes a comment that meets a presenter notification threshold.

In yet another embodiment, a level and type of notification that contextual program 200 sends to presenter device 140 may vary with the volume of data of the subset which meets a presenter notification threshold. For example, if contextual program 200 is receiving a sizeable amount of relevant comments, then contextual program 200 can send an alert (e.g., notification) for comments that receive a threshold score below ninety (90), while sending a SMS message that includes a comment for comments that receive a threshold score of ninety (90) or greater. In another example, contextual program 200 can send an alert (e.g., notification) for comments that come from viewers of the live stream broadcast, while receiving an SMS message from a moderator or high-value client.

In an example embodiment with respect to FIG. 3B, contextual program 200 sends a notification to presenter device 140. For example, in response to contextual program 200 determining that the threshold score of the comment of relevant comment section 326 (e.g., seventy-five (75)) is equal to the threshold presenter notification score of seventy-five (75), contextual program 200 sends an alert to a mobile device of speaker 312.

FIG. 4 depicts computer system 400, which is representative of client device 120A through client device 120N, server 130, and presenter device 140, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made. Computer system 400 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data 410) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 410 can be stored in persistent storage 405 for access and/or execution by one or more of the respective processor(s) 401 via cache 403. With respect to server 130, software and data 410 includes contextual program 200.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., software and data 410) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., software and data 410) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor. Display 409 can also function as a touch screen, such as the display of a tablet computer or a smartphone.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
determining, by one or more processors, a classification of content within a segment of a live stream;
identifying, by one or more processors, one or more messages in a chat session associated with the live stream that correspond to the segment of the live stream;
determining, by one or more processors, respective classifications corresponding to the identified one or more messages in the chat session associated with the live stream that correspond to the segment of the live stream; and
determining, by one or more processors, that a message of the identified one or more messages has a respective determined classification that correlates to the determined classification of the content within the segment of the live stream.

2. The method of claim 1, wherein determining a classification of content within a segment of a live stream, further comprises:
identifying, by one or more processors, audio content within the segment of the live stream; and
determining, by one or more processors, the classification of the content within the segment of the live stream based on a topic of the identified audio content.

3. The method of claim 1, wherein determining a classification of content within a segment of a live stream, further comprises:
identifying, by one or more processors, visual content within the segment of the live stream, wherein the visual content includes content selected from the group consisting of: unstructured text depicted within the segment of the live stream and objects depicted within the segment of the live stream; and
determining, by one or more processors, the classification of the content within the segment of the live stream based on the identified visual content.

4. The method of claim 1, wherein determining respective classifications corresponding to the identified one or more messages in the chat session, further comprises:
identifying, by one or more processors, a topic of a first message of the identified one or more messages in the chat session based on analyzing unstructured text of the first message; and
determining, by one or more processors, the respective classification corresponding to the first message based on the identified topic of the first message.

5. The method of claim 1, further comprising:
in response to determining that a score associated with the message of the identified one or more messages meets a notification threshold, generating, by one or more processors, a notification that includes the message.

6. The method of claim 1, further comprising:
generating, by one or more processors, a relevant chat session associated with the live stream, the relevant chat session including a subset of messages of the chat session associated with the live stream, including the determined message of the identified one or more messages.

7. The method of claim 5, further comprising:
determining, by one or more processors, the score associated with the message of the identified one or more messages based on factors selected from the group consisting of: a message source, a message type, message engagement, and a message topic.

8. A computer program product comprising:
one or more computer readable storage media and program instructions stored on the one or more computer readable storage media, the program instructions comprising:
program instructions to determine a classification of content within a segment of a live stream;
program instructions to identify one or more messages in a chat session associated with the live stream that correspond to the segment of the live steam;
program instructions to determine respective classifications corresponding to the identified one or more messages in the chat session associated with the live stream that correspond to the segment of the live stream; and
program instructions to determine that a message of the identified one or more messages has a respective determined classification that correlates to the determined classification of the content within the segment of the live stream.

9. The computer program product of claim 8, wherein the program instructions to determine a classification of content within a segment of a live stream, further comprise program instructions to:
identify audio content within the segment of the live stream; and
determine the classification of the content within the segment of the live stream based on a topic of the identified audio content.

10. The computer program product of claim 8, wherein the program instructions to determine a classification of content within a segment of a live stream, further comprise program instructions to:
identify visual content within the segment of the live stream, wherein the visual content includes content selected from the group consisting of: unstructured text depicted within the segment of the live stream and objects depicted within the segment of the live stream; and
determine the classification of the content within the segment of the live stream based on the identified visual content.

11. The computer program product of claim 8, wherein the program instructions to determine respective classifications corresponding to the identified one or more messages in the chat session, further comprise program instructions to:
identify a topic of a first message of the identified one or more messages in the chat session based on analyzing unstructured text of the first message; and
determine the respective classification corresponding to the first message based on the identified topic of the first message.

12. The computer program product of claim 8, further comprising program instructions, stored on the one or more computer readable storage media, to:
in response to determining that a score associated with the message of the identified one or more messages meets a notification threshold, generate a notification that includes the message.

13. The computer program product of claim 8, further comprising program instructions, stored on the one or more computer readable storage media, to:
generate a relevant chat session associated with the live stream, the relevant chat session including a subset of messages of the chat session associated with the live stream, including the determined message of the identified one or more messages.

14. The computer program product of claim 12, further comprising program instructions, stored on the one or more computer readable storage media, to:
determine the score associated with the message of the identified one or more messages based on factors selected from the group consisting of: message source, message type, message engagement, or message topic.

15. A computer system comprising:
one or more computer processors;
one or more computer readable storage media; and
program instructions stored on the computer readable storage media for execution by at least one of the one or more processors, the program instructions comprising:
program instructions to determine a classification of content within a segment of a live stream;
program instructions to identify one or more messages in a chat session associated with the live stream that correspond to the segment of the live steam;
program instructions to determine respective classifications corresponding to the identified one or more messages in the chat session associated with the live stream that correspond to the segment of the live stream; and
program instructions to determine that a message of the identified one or more messages has a respective determined classification that correlates to the determined classification of the content within the segment of the live stream.

16. The computer system of claim 15, wherein the program instructions to determine a classification of content within a segment of a live stream, further comprise program instructions to:
identify audio content within the segment of the live stream; and
determine the classification of the content within the segment of the live stream based on a topic of the identified audio content.

17. The computer system of claim 15, wherein the program instructions to determine a classification of content within a segment of a live stream, further comprise program instructions to:
identify visual content within the segment of the live stream, wherein the visual content includes content selected from the group consisting of: unstructured text depicted within the segment of the live stream and objects depicted within the segment of the live stream; and
determine the classification of the content within the segment of the live stream based on the identified visual content.

18. The computer system of claim 15, wherein the program instructions to determine respective classifications corresponding to the identified one or more messages in the chat session, further comprise program instructions to:
identify a topic of a first message of the identified one or more messages in the chat session based on analyzing unstructured text of the first message; and
determine the respective classification corresponding to the first message based on the identified topic of the first message.

19. The computer system of claim 15, further comprising program instructions, stored on the one or more computer readable storage media, to:
in response to determining that a score associated with the message of the identified one or more messages meets a notification threshold, generate a notification that includes the message.

20. The computer system of claim 15, further comprising program instructions, stored on the one or more computer readable storage media, to:
generate a relevant chat session associated with the live stream, the relevant chat session including a subset of messages of the chat session associated with the live stream, including the determined message of the identified one or more messages.
